(19) United States
(12) Patent Application Publication
(10) Pub. No.: US 2020/0329749 A1
(43) Pub. Date: Oct. 22, 2020

(54) SEAWEED MEAL AND METHOD OF MAKING THE SAME

(71) Applicant: NUTRIOMIX, INC., Pasadena, CA (US)

(72) Inventor: Lijun SUN, La Canada Flintridge, CA (US)

(21) Appl. No.: 16/921,837

(22) Filed: Jul. 6, 2020

Related U.S. Application Data
(63) Continuation of application No. 16/010,343, filed on Jun. 15, 2018.
(60) Provisional application No. 62/671,302, filed on May 14, 2018.

(51) Int. Cl. A23L 17/60; A23L 17/00; A23L 5/49

(52) U.S. Cl. CPC A23L 17/60; A23V 2002/00; A23L 5/49; A23L 17/65

(57) ABSTRACT

Provided are methods of making high quality seaweed meal suitable for food applications. The method comprises the steps of cleaning the fresh, dried, or rehydrated red seaweed, pretreating the red seaweed with a salt under heat, and drying and grinding the treated red seaweed to obtain the seaweed meal. Optionally, the method comprises bleaching the red seaweed, and/or hydrolyzing the red seaweed with cellulase. The seaweed meal produced by the disclosed technology has a light color, good flavor and taste, good mouthfeel, high gelling capability, great stability, and ideal smoothness and slipperiness suitable for food applications.

### CROSS-REFERENCE TO RELATED APPLICATIONS

This application is a continuation of U.S. patent application Ser. No. 16/010,343, filed Jun. 15, 2018, which claims the benefit of U.S. Provisional Application No. 62/671,302, filed May 14, 2018.

### TECHNICAL FIELD

This disclosure relates to seaweed meal and a method of making the same. The seaweed meal disclosed herein can replace the use of carrageenan. The method and the seaweed meal production can be used in the field of food industry.

### BACKGROUND

Carrageenans are linear sulfated polysaccharides extracted from edible red seaweeds. They are used in food industry, particularly in dairy and meat products, to bind to food proteins and help stabilize and texturize the food products. Therefore, carrageenans have wide applications in food industry as gelling agents, thickening agents, and stabilizing agents. Carrageenan is an animal-product-free ingredient replacing gelatin in vegetarian food products.

Clean Label and disruptive Green have become more and more popular in food industrials, and have been listed in the “Top 10 Innova's 2017 Trends,” resulting in strong interests in naturalness and clean label. This trend has been growing globally for the past couple of years and is the new standard in the industry. It provides vast market space development potential for seaweed meal to replace carrageenan in food application.

US Patent Application Publication No. 2015/0164125 describes a method for making seaweed meal, including the steps of harvesting the seaweed from a sea floor; chopping the seaweed; cleaning the seaweed; desiccating the seaweed; grinding the seaweed to a meal; drying the seaweed between the cleaning step and the desiccating step, the drying step is accomplished by a seaweed agitator. U.S. Pat. No. 4,125,392 describes a seaweed filter cake product produced by conditioning raw seaweed by mixing it with water and other substances, and then digesting the conditioned seaweed by cooking it with steam to form a steam-digested mixture. The filter cake is skimmed off the top of the resulting steam-digested mixture and used by itself, or as a starting product for producing fertilizers or plant growth stimulators in liquid or pelletized form.

The prior-art references merely produced a simple seaweed meal or cake products, with poor gelling capability, brown or green color, and strong fishery flavor. These prior-art seaweed products are not suitable for use as gelling agent or stabilizer in food applications to replace carrageenan extracted from red seaweed. Thus, there is a need in the field to produce better quality seaweed meal suitable for food applications.

### SUMMARY

In one aspect, provided herein is a method of making a seaweed meal to replace carrageenan in the food industry. The method comprises the steps of cleaning the fresh or dried red seaweed, pretreating the red seaweed with a salt under heat, and drying and grinding the treated red seaweed to obtain the seaweed meal. Optionally, the method comprises a step of bleaching the red seaweed with a bleaching agent before the drying and grinding step. Optionally, the method comprises a step of treating the red seaweed with an enzyme such as a cellulase before the drying and grinding step. In some embodiments, the bleaching step is carried out before the enzyme treatment step. In some embodiments, the bleaching step is carried out after the enzyme treatment step. The disclosure provides a simple process to produce a seaweed meal with light color, good flavor and taste, good mouthfeel, high gelling capability, great stability, and ideal smoothness and slipperiness suitable for “clean label” food applications.

In a related aspect, provided herein is a seaweed meal produced by the method described above. The seaweed meal produced by the disclosed method can be used in food industry to replace carrageenan as a gelling ingredient in, for example, dairy, jelly, pudding or meat products.

### DETAILED DESCRIPTION

Methods for making high quality seaweed meal suitable for food applications are provided herein. The method is a simple process to produce a seaweed meal with desired features such as light color, good flavor and taste, good mouthfeel, high gelling capability, great stability, and ideal smoothness and slipperiness suitable for food applications. The seaweed meal produced by the disclosed method can be used in food industry to replace carrageenan as a gelling agent in, for example, producing dairy, jelly, pudding, or meat products.

In some embodiments, the method disclosed herein comprises the steps of cleaning seaweed material with water, pre-treating the clean seaweed material with a salt under heat, bleaching the pre-treated seaweed material with a bleaching agent, and treating the bleached seaweed material with an enzyme to obtain a seaweed meal suitable for food applications. The bleaching step is optional and can be included if a light color seaweed meal is desired. The enzyme treatment step is also optional and can be carried out before or after the bleaching step if both of these optional steps are included.

Seaweed is also called macroalgae, marine algae, or seagrass. The seaweed material used for the disclosed method includes red seaweed, for example, Chondrus, Gigartina, Kappaphycus, and Eucheuma. In some embodiments, a combination of at least two, at least three, or at least four of the disclosed red seaweed can be used. The seaweed material is cleaned by water prior to any treatment. Seaweed materials in any form such as dry seaweed, or fresh seaweed, or rehydrated seaweed, material can be used. It is known in the art that fresh seaweed can be dehydrated to obtain dry seaweed. The dry seaweed can be rehydrated by soaking the dry seaweed in water. In some embodiments, the dry seaweed is rehydrated during the cleaning step. When dry seaweed is used, the dry seaweed:water ratio in the cleaning step can be between 1:1 and 1:40, between 1:3 and 1:30, between 1:5 and 1:25, between 1:5 and 1:20, between 1:10 and 1:20, or between 1:5 and 1:10; when fresh seaweed or rehydrated seaweed is used, the fresh seaweed:water ratio in the cleaning step can be between 1:1 and 1:3, between 1:1 and 1:5, between 1:2 and 1:5, between 1:1 and 1:10, or between 1:1 and 1:15.

Salt pre-treatment process is an environment-friendly process to produce a seaweed meal with good gel capability and/or stability, while retaining more natural health promoting ingredients. This simplified process generates less waste water and is more environmental friendly, compared to the traditional alkali and/or acid pre-treatment process. Therefore, the disclosed technology can produce high quality seaweed meal in a time-efficient and cost-effective manner.

The salts that can be used for the disclosed method include one or more salts of one or more metals and one or more acids. Examples of the one or more metals for the one or more salts include, without limitation, alkaline metals (e.g., Li, Na, K, Rb) and alkaline-earth metals (e.g., Be, Mg, Ca, Sr), and examples of the one or more acids for the one or more salts include, without limitation, HX (e.g., X is halogen such as F, Cl, Br, I), sulfuric acid, and carbonic acid. Examples of suitable salt include, without limitation, sodium chloride, potassium chloride, sodium carbonate, sodium bicarbonate, potassium carbonate, potassium bicarbonate, sodium citrate, and sodium tartaric acid. In some embodiments, a combination of at least two, at least three, at least four, at least five, or at least six salts can be used in the pre-treatment. In the pre-treatment step, the seaweed:salt ratio can be between 1:1 and 1:3, between 1:1 and 1:5, between 1:2 and 1:5, or between 1:1 and 1:10. The salt solution can be at a concentration of between 1% and 10%, between 5% and 15%, between 3% and 20%, between 5% and 25%, between 10% and 30%, or between 5% and 30% (wt %). In some embodiments, the salt pre-treatment step is performed at a temperature between 40° C. and 80° C., between 50° C. and 100° C., between 60° C. and 90° C., or between 70° C. and 120° C. In some embodiments, the salt pre-treatment can be performed for a period of between 0.5 hour and 24 hours, between 0.5 hour and 20 hours, between 0.5 hour and 15 hours, between 0.5 hour and 12 hours, between 0.5 hour and 8 hours, between 0.5 hour and 6 hours, between 1 hour and 4 hours, between 1.5 hours and 3 hours, or between 0.5 hour and 4 hours.

Optionally, the seaweed is treated with a bleaching agent to obtain a light color seaweed meal. The bleaching agent that can be used for the disclosed method includes hypochlorous acid, sodium hypochlorous, and chlorine dioxide. Alternatively, a combination of the disclosed bleaching agents, such as a combination of at least two bleaching agents, or at least three bleaching agents, can be used. In the bleaching step, the seaweed:bleaching agent ratio can be between 1:1 and 1:3, between 1:1 and 1:5, between 1:2 and 1:5, or between 1:1 and 1:10. The bleaching agent can be at a concentration of available chlorine content of between 0.01% and 5%, between 0.02% and 3%, between 0.05% and 2%, between 0.05% and 1%, between 0.05% and 0.5%, or between 0.01% and 0.1% (wt %). In some embodiments, the bleaching step can be performed for a period of between 5 minutes and 240 minutes, between 10 minutes and 180 minutes, between 10 minutes and 120 minutes, between 10 minutes and 60 minutes, or between 20 minutes and 60 minutes.

In some embodiments, the pre-treated or bleached seaweed has an impurity of the red seaweed of less than 5%, less than 4%, less than 3%, less than 2%, or less than 1%, and a color of light brown to light yellow.

The enzyme treatment catalyzes the hydrolysis of the cellulose and/or related polysaccharides or the like in the pre-treated and/or bleached seaweed such that the obtained seaweed meal has an improved mouthfeel. Various enzymes may be used to achieve this goal, for example, cellulase, hemicellulose, pectinase, amylase, xylanase, pentosanase, glucanase, esterase. In some embodiments, one or more enzymes can be used to treat the seaweed. An example of the suitable enzyme is cellulase, including acid cellulase, neutral cellulase, and alkali cellulose, including but not limited to 1,4-β-D-glucan glucanohydrolase, endo-1,4-β-D-glucanase, 1,4-β-D-glucan cellobilhydrolase, exo-1,4-β-D-glucannase, μ-1,4-glucosidase, from Trichoderma, Aspergillus or Penicillium. In some embodiments, a combination of at least two, at least three, or more of these cellulases can be used. In the enzyme treatment step, the seaweed:enzyme ratio can be between 1:1 and 1:3, between 1:2 and 1:5, between 1:1 and 1:5, between 1:1 and 1:6 or between 1:1 and 1:10. The enzyme can be at a concentration of between 10 U/g and 500 U/g, between 20 U/g and 400 U/g, between 30 U/g and 300 U/g, between 50 U/g and 200 U/g, or between 75 U/g and 150 U/g. In some embodiments, the enzyme treatment step can be performed for a period of between 0.5 hour and 12 hours, between 0.5 hour and 8 hours, between 0.5 hour and 6 hours, between 1 hour and 3 hours, or between 1 hour and 4 hours, at a pH range of between 2.0 and 10.0, between 3.0 and 9.0, between 3.0 and 8.0, between 4.0 and 7.0, or between 5.0 and 6.0, or at a temperature between 15° C. and 100° C., between 20° C. and 90° C., between 30° C. and 80° C., between 20° C. and 70° C., between 30° C. and 60° C., or between 40° C. and 50° C.

A variety of acids or alkalis can be used to adjust pH. For example, the alkali for pH adjustment is selected from the group consisting of sodium hydroxide, potassium hydroxide, and a combination thereof. The acid for pH adjustment is selected from the group consisting of hydrochloric acid, nitric acid, phosphate acid, and a combination of at least two, or at least three of these acids.

In some embodiments, the clean seaweed is pre-treated with between 5% and 30% (wt %) of a salt solution at a ratio of between 1:2 and 1:5 and at a temperature of between 50° C. and 90° C., and then treated with a cellulase having a concentration of between 30 U/g and 200 U/g at a ratio of between 1:2 and 1:5 and at a temperature of between 40° C. and 60° C.

The treated seaweed can be dried and grinded to obtain the seaweed meal. In some embodiments, the dried seaweed meal has a sulfate content of between 1% and 50%, between 10% and 45%, between 5% to 40% or between 15% and 30%. In some embodiments, the viscosity of the dried seaweed meal is at least 0.005 Pa·S. In some embodiments, the dried seaweed meal has a color of light brown to light yellow.

The following examples are intended to illustrate various embodiments of the invention. As such, the specific embodiments discussed are not to be construed as limitations on the scope of the invention. It will be apparent to one skilled in the art that various equivalents, changes, and modifications may be made without departing from the scope of invention, and it is understood that such equivalent embodiments are to be included herein. Further, all references cited in the disclosure are hereby incorporated by reference in their entirety, as if fully set forth herein.

### EXAMPLES

### Example 1: Materials and Methods

The algae materials used in the experiments are as follows:

TABLE 1
Algae Materials

| Algae Materials | Purity | Moisture Content |
|---|---|---|
| Dried Kappaphycus | 95% | 19% |
| Fresh Kappaphycus | 97% | 83% |
| Dried Eucheuma | 93% | 28% |
| Fresh Eucheuma | 94% | 82% |
| Dried Chondrus | 94% | 18% |
| Dried Gigartina | 96% | 21% |

Other reagents include: hypochlorous acid, sodium hypochlorous, available chlorine contents 10%, food grade; chlorine dioxide, available chlorine contents 50%, food grade; hydrochloric acid, 36%, food grade; and sulfuric acid, nitric acid, phosphate acid, 99%, food grade; sodium hydroxide, potassium hydroxide, 99% food grade; acid cellulase, neutral cellulase, alkaline cellulase, 50,000 U/g, food grade; sodium chloride, potassium chloride, sodium carbonate, sodium bicarbonate, potassium carbonate, potassium bicarbonate, 99%, food grade.

### Example 2: Preparation of Seaweed Meal from Dried Eucheuma

10 kg dried Eucheuma was mixed with 50 kg water in the tank, stirred at 60 RPM for 30 minutes to clean the seaweed, and then the water was removed to obtain 50 kg clean seaweed. The clean seaweed was mixed with 50 kg 5% sodium chloride solution in the reaction tank, the mixture was heated and the temperature was kept at 50° C., with stirring at 60 RPM for 30 minutes, followed by washing the seaweed with 500 kg water. Once the water was removed, 49 kg of salt pre-treated seaweed was obtained. The salt pre-treated seaweed was mixed with 49 kg of 0.01% bleaching agent, hydrochloric acid (HClO) solution in the tank, stirred at 60 RPM for 10 minutes, then the hypochlorous acid solution was removed, and the seaweed was washed with 100 kg water. Once the water was removed 47 kg pre-treated seaweed was obtained. The specification of the pre-treated seaweed was: impurity of the red seaweed s 0.5%, and the color was yellow.

Subsequently, the pre-treated seaweed was mixed with 47 kg of 30 U/g acid cellulase solution, pH was adjusted to 3.0 using hydrochloric acid, and the temperature was kept at 20° C., with stirring at 60 RPM for 30 minutes. Then the cellulase solution was removed and the seaweed was washed with 100 kg water. 45 kg cellulase treated seaweed was obtained. And then the seaweed was dried and grinded to obtain 4.1 kg seaweed meal.

### Example 3: Preparation of Seaweed Meal from Fresh Eucheuma

50 kg fresh Eucheuma was mixed with 120 kg water in the tank, and stirred at 60 RPM for 30 minutes to clean the seaweed. The water was removed to obtain 48 kg clean seaweed. The clean seaweed was mixed with 120 kg of 20% potassium chloride solution in the reaction tank. The mixture was heated and the temperature was kept at 80° C., with stirring at 60 RPM for 120 minutes. The seaweed was washed with 600 kg water, and the water was removed to obtain 47 kg salt pre-treated seaweed. The salt pre-treated seaweed was mixed with 120 kg of 0.05% bleaching agent, sodium hypochlorous acid solution, stirred at 60 RPM for 30 minutes, the sodium hypochlorous acid solution was removed, and followed by washing with 100 kg water. The water was removed to obtain 46 kg pre-treated seaweed. The specification of the pre-treated seaweed was: impurity of the red seaweed s 0.3%, and the color was light yellow.

The pre-treated seaweed was mixed with 120 kg of 100 U/g cellulase solution, pH was adjusted to 5.0 with sulfuric acid, heated and the temperature was kept at 50° C., with stirring at 60 RPM for 120 minutes. The cellulase solution was removed and the seaweed was washed with 100 kg water. 44 kg of cellulase treated seaweed was obtained. And then the seaweed was dried and grinded to obtain 3.9 kg seaweed meal.

### Example 4: Preparation of Seaweed Meal from Dried Eucheuma

10 kg dried Eucheuma was mixed with 250 kg water in the tank, and stirred at 60 RPM for 30 minutes to clean the seaweed. The water was removed to obtain 50 kg clean seaweed. The clean seaweed was mixed with 250 kg 30% sodium carbonate solution in the reaction tank. The mixture was heated and kept at a temperature of 100° C., with stirring at 60 RPM for 12 hours. Then the seaweed was washed with 600 kg water. The water was removed to obtain 45 kg salt pre-treated seaweed. The salt pre-treated seaweed was mixed with 225 kg 0.5% bleaching agent, chlorine dioxide solution, stirred at 60 RPM for 120 minutes, and then the chlorine dioxide solution was removed, followed by washing with 200 kg water. The water was removed to obtain 42 kg pre-treated seaweed. The specification of the pre-treated seaweed was: impurity of the red seaweed s 0.6%, and the color was yellow.

The pre-treated seaweed was mixed with 210 kg of 300 U/g neutral cellulase solution, pH was adjusted to 8.0 with sodium hydroxide solution, heated and the temperature was kept at 70° C., with stirring at 60 RPM for 6 hours. The cellulase solution was removed and the seaweed was washed with 200 kg water. 36 kg cellulase treated seaweed was obtained. And then the seaweed was dried and grinded to obtain 3.1 kg seaweed meal.

### Example 5: Preparation of Seaweed Meal from Fresh Kappaphycus

50 kg fresh Kappaphycus was mixed with 50 kg water in the tank, and stirred at 60 RPM for 30 minutes to clean the seaweed. The water was removed to obtain 49 kg clean seaweed. The clean seaweed was mixed with 49 kg 5% sodium bicarbonate solution in the reaction tank. The mixture was heated and kept at a temperature of 50° C., with stirring at 60 RPM for 30 minutes, then the seaweed was washed with 500 kg water. The water was removed to obtain 42 kg salt pre-treated seaweed. The salt pre-treated seaweed was mixed with 42 kg of 0.01% bleaching agent, hypochlorous acid (HClO) solution, stirred at 60 RPM for 10 minutes. And then the hypochlorous acid solution was removed, and the seaweed was washed with 100 kg water. The water was removed to obtain 41 kg pre-treated seaweed. The specification of the pre-treated seaweed was: impurity of the red seaweed s 0.4%, and the color was yellow.

The pre-treated seaweed was mixed with 41 kg of 30 U/g alkali cellulase solution, pH was adjusted to 8.0 using sodium hydroxide, and the temperature was kept at 20° C., with stirring at 60 RPM for 30 minutes. The cellulase solution was removed and the seaweed was washed with 100 kg water. 38 kg cellulase treated seaweed was obtained. And then the seaweed was dried and grinded to obtain 3.3 kg seaweed meal.

### Example 6: Preparation of Seaweed Meal from Dried Kappaphycus

10 kg dried Kappaphycus was mixed with 120 kg water in the tank, and stirred at 60 RPM for 30 minutes to clean the seaweed. The water was removed to obtain 49 kg clean seaweed. The clean seaweed was mixed with 120 kg of 20% sodium chloride solution in the reaction tank. The mixture was heated and kept at a temperature of 80° C., with stirring at 60 RPM for 120 minutes, and then washed with 600 kg water. The water was removed to obtain 48 kg salt pre-treated seaweed. The salt pre-treated seaweed was mixed with 120 kg of 0.05% bleaching agent, hypochlorous acid solution, stirred at 60 RPM for 30 minutes. The hypochlorous acid solution was removed, and the seaweed was washed with 100 kg water. The water was removed to obtain 46 kg pre-treated seaweed. The specification of the pre-treated seaweed was: impurity of the red seaweed s 0.2%, and the color was light yellow.

The pre-treated seaweed was mixed with 120 kg of 100 U/g cellulase solution, pH was adjusted to 4.8 with phosphate acid, heated and the temperature was kept at 45° C., with stirring at 60 RPM for 120 minutes. The cellulase solution was removed and the seaweed was washed with 100 kg water. 43 kg of cellulase treated seaweed was obtained. And then the seaweed was dried and grinded to obtain 3.8 kg seaweed meal.

### Example 7: Preparation of Seaweed Meal from Dried Kappaphycus

10 kg Kappaphycus was mixed with 150 kg water in the tank, and stirred at 60 RPM for 30 minutes to clean the seaweed. The water was removed to obtain 49 kg clean seaweed. The clean seaweed was dried and grinded to obtain 4.8 kg seaweed meal.

### Example 8: Preparation of Seaweed Meal from Dried Gigartina

10 kg dried Gigartina was mixed with 80 kg water in the tank, and stirred at 60 RPM for 2 hours to clean the seaweed. The water was removed to obtain 49 kg clean seaweed. The clean seaweed was mixed with 80 kg of 8% potassium bicarbonate solution in the reaction tank. The mixture was heated and kept at a temperature of 60° C., with stirring at 60 RPM for 1 hour, and then washed with 600 kg water. The water was removed to obtain 45 kg salt pre-treated seaweed. The salt pre-treated seaweed was mixed with 80 kg of 0.03% bleaching agent, sodium hypochlorous acid solution, and stirred at 60 RPM for 20 minutes. The sodium hypochlorous acid solution was removed, and the seaweed was washed with 100 kg water. The water was removed to obtain 45 kg pre-treated seaweed. The specification of the pre-treated seaweed was: impurity of the red seaweed s 0.6%, and the color was light brown.

The pre-treated seaweed was mixed with 90 kg of 60 U/g acid cellulase solution, pH was adjusted to 4.0 with nitric acid, heated and the temperature was kept at 40° C., with stirring at 60 RPM for 1 hour. The cellulase solution was removed and the seaweed was washed with 100 kg water. 40 kg cellulase treated seaweed was obtained. And then the seaweed was dried and grinded to obtain 3.2 kg seaweed meal.

### Example 9: Preparation of Seaweed Meal from Dried Chondrus

10 kg dried Chondrus was mixed with 200 kg water in the tank, and stirred at 60 RPM for 30 minutes to clean the seaweed. The water was removed to obtain 49 kg clean seaweed. The clean seaweed was mixed with 200 kg of 25% potassium chloride solution in the reaction tank, heated and kept at a temperature of 90° C., with stirring at 60 RPM for 8 hours, and then washed with 600 kg water. The water was removed to obtain 45 kg salt pre-treated seaweed. The salt pre-treated seaweed was mixed with 200 kg of 0.08% bleaching agent, sodium hypochlorous acid solution, stirred at 60 RPM for 90 minutes, and then the sodium hypochlorous acid solution was removed, and the seaweed was washed with 100 kg water. The water was removed to obtain 44 kg pre-treated seaweed. The specification of the pre-treated seaweed was: impurity of the red seaweed s 0.5%, and the color was light brown.

The pre-treated seaweed was mixed with 200 kg of 200 U/g neutral cellulase solution, pH was adjusted to 7.5 with potassium hydroxide, heated and the temperature was kept at 60° C., with stirring at 60 RPM for 240 minutes. The cellulase solution was removed and the seaweed was washed with 100 kg water. 41 kg cellulase treated seaweed was obtained. And then the seaweed was dried and grinded to obtain 3.6 kg seaweed meal.

### Example 10: Basic Analysis of the Seaweed Meal Preparations

Table 2 summarizes the treatment of Examples 2-9 to obtain various seaweed meal preparations.

TABLE 2
Seaweed Meal Preparations

| Sam- | Exam- | | | |
|---|---|---|---|---|
| ple | ple | | Salt, bleaching | |
| No. | No. | Seaweed Type | agent | Enzyme |
| 1 | 2 | Dried Eucheuma | NaCl, HClO | Acid cellulase |
| 2 | 3 | Fresh Eucheuma | KCl, NaClO | Acid cellulase |
| 3 | 4 | Dried Eucheuma | NaCO₃, ClO₂ | Neutral cellulase |
| 4 | 5 | Fresh | NaHCO₃, HClO | Alkali cellulase |
| | | Kappaphycus | | |
| 5 | 6 | Dried | NaCl, HClO | Acid cellulase |
| | | Kappaphycus | | |
| 6 | 7 | Dried | No treatment | No treatment |
| | | Kappaphycus | | |
| 7 | 8 | Dried Gigartina | KHCO₃, NaClO | Acid cellulase |
| 8 | 9 | Dried Chondrus | KCl, NaClO | Neutral cellulase |

The sulfate test was performed as follows: 100 mg sample was dissolved in 20 ml of water (with heating if necessary), and 3 ml of barium chloride test solution and 5 ml of hydrochloric acid were added. The test solution was diluted and filtered if a precipitate formed. The solution or the filtrate was boiled for 5 minutes. A white, crystalline precipitate appeared.

Viscosity test was performed as follows: 1.5 grams of seaweed meal was weighed and dispersed into 98.5 grams deionized water under stirring with IKA (500-600 rpm) for 10 min, heated to 80° C., and the solution was kept in a water bath at 75° C. The viscosity was tested with Brookfield LVT, Spindle #2, at 60 rpm.

Application test was performed in neutral dairy, with a formula of the prototype in Table 3.

TABLE 3
Formula of the Prototype

| Sample | Contents (%) |
|---|---|
| Fresh milk | 80 |
| Seaweed meal | 0.005-0.02 |
| Water | Make up to 100 |

Table 4 illustrates the process of preparing dairy products with seaweed meal.

TABLE 4
Process of Preparing Dairy Products with Seaweed Meal

| Steps | Description |
|---|---|
| 1 | Heat milk to 60° C. |
| 2 | Add seaweed meal, Stir milk at 600-800 rpm |
| | for about 10 min. |
| 3 | Add water to total weight under stirring |
| | at the speed of 600-800 rpm. |
| 4 | Heat seaweed meal milk to 60° C. |
| 5 | Homogenize milk sample at 60° C. |
| | under 200 bar/40 bar. |
| 6 | Sterilize milk sample at 132° C. |
| | for 5 second by UHT equipment. |
| 7 | Fill the carrageenan milk in PET |
| | bottle at room temperature. |

Table 5 summarizes the results of the basic analysis of the seaweed meal preparation samples 1-8, obtained from Examples 2-9.

TABLE 5
Results of Seaweed Meal Analysis

| Sample | | Viscosity | | Sulfate | Application in |
|---|---|---|---|---|---|
| No. | Yield | (mPa · S) | Color | (%) | Neutral Dairy |
| 1 | 41% | 121 | Light | 16 | Body, More |
| | | | yellow | | smoothness, less |
| | | | | | roughness |
| 2 | 39% | 182 | Light | 21 | Body, Smoothness |
| | | | yellow | | |
| 3 | 31% | 110 | Light | 17 | Body, More |
| | | | yellow | | smoothness, less |
| | | | | | roughness |
| 4 | 33% | 70 | Light | 12 | Body, More |
| | | | yellow | | smoothness, less |
| | | | | | roughness |
| 5 | 38% | 91 | Yellow | 8 | Body, Smoothness |
| 6 | 58% | 20 | Brown | 6 | Thin, roughness |
| 7 | 32% | 60 | Light | 15 | Body, More |
| | | | brown | | smoothness, less |
| | | | | | roughness |
| 8 | 36% | 77 | Light | 16 | Body, More |
| | | | yellow | | smoothness, less |
| | | | | | roughness |

Samples 2 and 5 produced the best results in various tests. Samples 7 and 8 also produced acceptable results in various tests.

1. A method of preparing a high quality seaweed meal suitable for food applications, comprising:
cleaning seaweed material with water, wherein the seaweed material is dry, fresh, or rehydrated seaweed material; and
pre-treating the seaweed with a salt under heat;
thereby to obtain the seaweed meal.

2. The method of claim 1, further comprising bleaching the seaweed with a bleaching agent.

3. The method of claim 2, wherein the bleaching step is performed with a seaweed:bleaching solution ratio of between 1:1 and 1:3, between 1:1 and 1:5, between 1:2 and 1:5, or between 1:1 and 1:10.

4. The method of claim 2, wherein the bleaching step is performed with a concentration of available chlorine content of between 0.01% and 5%, between 0.02% and 3%, between 0.05% and 2%, between 0.05% and 1%, between 0.05% and 0.5%, or between 0.01% and 0.1% (wt %).

5. The method of claim 2, wherein the bleaching step is performed for a period of between 5 minutes and 240 minutes, between 10 minutes and 180 minutes, between 10 minutes and 120 minutes, between 10 minutes and 60 minutes, or between 20 minutes and 60 minutes.

6. The method of claim 2, wherein the bleaching agent is selected from the group consisting of hypochlorous acid, sodium hypochlorous, chlorine dioxide, and a combination thereof.

7. The method of claim 1, further comprising treating the seaweed with an enzyme to improve mouthfeel of the seaweed meal, wherein the enzyme is cellulase.

8. The method of claim 7, wherein the enzyme treatment step is performed with a seaweed:enzyme ratio of between 1:1 and 1:3, between 1:2 and 1:5, between 1:1 and 1:5, between 1:1 and 1:6 or between 1:1 and 1:10.

9. The method of claim 7, wherein the enzyme treatment step is performed at a pH range of between 2.0 and 10.0, between 3.0 and 9.0, between 3.0 and 8.0, between 4.0 and 7.0, or between 5.0 and 6.0.

10. The method of claim 7, wherein the enzyme treatment step is performed at a concentration of the enzyme between 10 U/g and 500 U/g, between 20 U/g and 400 U/g, between 30 U/g and 300 U/g, between 50 U/g and 200 U/g, or between 75 U/g and 150 U/g.

11. The method of claim 7, wherein the enzyme treatment step is performed at a temperature of between 15° C. and 100° C., between 20° C. and 90° C., between 30° C. and 80° C., between 20° C. and 70° C., between 30° C. and 60° C., or between 40° C. and 50° C.

12. The method of claim 7, wherein the enzyme treatment step is performed for a period of between 0.5 hour and 12 hours, between 0.5 hour and 8 hours, between 0.5 hour and 6 hours, between 1 hour and 3 hours, or between 1 hour and 4 hours.

13. The method of claim 7, wherein the enzyme is selected from the group consisting of acid cellulase, neutral cellulase, alkali cellulase, and a combination thereof.

14. The method of claim 1, further comprising drying and grinding the seaweed.

15. The method of claim 1, wherein the pre-treated seaweed has an impurity of the red seaweed of less than 1%, and a color of light brown to light yellow.

16. The method of claim 1, wherein the seaweed material is red algae.

17. The method of claim 1, wherein the seaweed material comprises Chondrus, Gigartina, Kappaphycus, Eucheuma, or a combination thereof.

18. The method of claim 1, wherein the cleaning step is performed with a fresh seaweed:water ratio of between 1:1 and 1:3, between 1:1 and 1:5, between 1:2 and 1:5, between 1:1 and 1:10, or between 1:1 and 1:15, or a dried seaweed:water ratio of between 1:1 and 1:40, between 1:3 and 1:30, between 1:5 and 1:25, between 1:5 and 1:20, between 1:10 and 1:20, or between 1:5 and 1:10.

19. The method of claim 1, wherein the salt pre-treatment step is performed with a seaweed:salt solution ratio of between 1:1 and 1:3, between 1:1 and 1:5, between 1:2 and 1:5, or between 1:1 and 1:10.

20. The method of claim 1, wherein the salt pre-treatment step is performed with a concentration of the salt solution between 1% and 10%, between 5% and 15%, between 3% and 20%, between 5% and 25%, between 10% and 30%, or between 5% and 30% (wt %).

21. The method of claim 1, wherein the salt pre-treatment step is performed at a temperature between 40° C. and 80° C., between 50° C. and 100° C., between 60° C. and 90° C., or between 70° C. and 120° C.

22. The method of claim 1, wherein the salt pre-treatment step is performed for a period of between 0.5 hour and 24 hours, between 0.5 hour and 20 hours, between 0.5 hour and 15 hours, between 0.5 hour and 12 hours, between 0.5 hour and 8 hours, between 0.5 hour and 6 hours, between 1 hour and 4 hours, between 1.5 hours and 3 hours, or between 0.5 hour and 4 hours.

23. The method of claim 1, wherein the salt is selected from the group consisting of sodium chloride, potassium chloride, sodium carbonate, sodium bicarbonate, potassium carbonate, potassium bicarbonate, sodium citrate, sodium tartaric acid, and a combination thereof.

24. A seaweed meal suitable for food applications produced by the method of claim 1.

25. The seaweed meal of claim 24, wherein the seaweed meal has a sulfate content of between 5% to 40%, a viscosity of at least 0.005 Pa·S, or a color of light brown to light yellow.

26. A seaweed meal suitable for food applications produced by the method of claim 2.

27. The seaweed meal of claim 26, wherein the seaweed meal has a sulfate content of between 5% to 40%, a viscosity of at least 0.005 Pa·S, or a color of light brown to light yellow.

28. A seaweed meal suitable for food applications produced by the method of claim 7.

29. The seaweed meal of claim 28, wherein the seaweed meal has a sulfate content of between 5% to 40%, a viscosity of at least 0.005 Pa·S, or a color of light brown to light yellow.
